(19) United States
(12) Patent Application Publication
(10) Pub. No.: US 2026/0148080 A1
(43) Pub. Date: May 28, 2026

(54) METHOD AND SYSTEM FOR EXTERNAL ANTICIPATION MECHANISM AND APPLICATION THEREOF

(71) Applicant: Verizon Patent and Licensing Inc., Basking Ridge, NJ (US)

(72) Inventors: Stanislav Olegovich Miasnikov, Newark, CA (US); Brita Young, Denver, CO (US); Aleksei Maximillian Kac, Parker, CO (US)

(73) Assignee: Verizon Patent and Licensing Inc., Basking Ridge, NJ (US)

(21) Appl. No.: 18/962,023

(22) Filed: Nov. 27, 2024

(51) Int. Cl. G06N 3/091

(52) U.S. Cl. CPC G06N 3/091

(57) ABSTRACT

The present teaching relates to external anticipation for LLMs. Historical context relevant to a current block of tokens from a communication is identified and used for predicting future tokens. An augmented input is created via historical context and a predicted sequence of tokens including the current block and predicted future tokens and sent to LLMs. An actual sequence of tokens includes the current block and a next block of tokens from the communication. When a deviation is detected between the actual and the predicted sequences of tokens, a restart signal is sent to LLMs to initiate a restart process in generating the response.

### BACKGROUND

In recent years, generative artificial intelligence (AI) has been applied to develop different products. The backend basis for the operation of a generative AI product includes a large language model (LLM) trained for either a generic purpose or a specific purpose associated with a particular type of applications. For example, some LLMs may carry on a dialogue with a user, answering questions from the user with responses and/or creating content at the request of the user. With the increasingly popular use of such generative AI products in different scenarios, issues have been raised with respect to the quality of the content output from such products.

### BRIEF DESCRIPTION OF THE DRAWINGS

The methods, systems and or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates a typical setting of an LLM-based response generator for generating responses in response to queries;

FIG. 2 depicts an exemplary framework of generating responses using LLM with an external anticipation engine to provide augmented input with improved context, in accordance with an embodiment of the present teaching;

FIG. 3A depicts an exemplary system diagram of an external anticipation engine, in accordance with an embodiment of the present teaching;

FIG. 3B is a flowchart of an exemplary process of an external anticipation engine, in accordance with an embodiment of the present teaching;

FIG. 4A depicts an exemplary system diagram of a historical context identifier, in accordance with an embodiment of the present teaching;

FIG. 4B illustrates exemplary construct of historical content and an example historical context window for extracting relevant historical context, in accordance with an embodiment of the present teaching;

FIG. 4C is a flowchart of an exemplary process of a historical context identifier, in accordance with an embodiment of the present teaching;

FIG. 5A depicts an exemplary system diagram of an anticipation unit, in accordance with an embodiment of the present teaching;

FIG. 5B shows look-ahead anticipation based on input tokens and related historical context, in accordance with an embodiment of the present teaching;

FIG. 5C is a flowchart of an exemplary process of an anticipation unit, in accordance with an embodiment of the present teaching;

FIG. 6A depicts an exemplary system diagram of a restart signal generator, in accordance with an embodiment of the present teaching;

FIG. 6B is a flowchart of an exemplary process of a restart signal generator, in accordance with an embodiment of the present teaching;

FIG. 7 is an illustrative diagram of an exemplary mobile device architecture that may be used to realize a specialized system implementing the present teaching in accordance with various embodiments; and

FIG. 8 is an illustrative diagram of an exemplary computing device architecture that may be used to realize a specialized system implementing the present teaching in accordance with various embodiments.

### DETAILED DESCRIPTION OF EXAMPLE EMBODIMENTS

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or systems have been described at a relatively high-level, without detail, in order to avoid unnecessarily obscuring aspects of the present teachings.

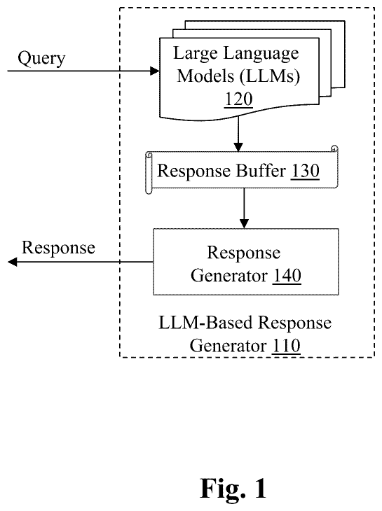

With the recent increased popularity of generative AI products, more and more companies deploy products developed based on such technology in various applications to achieve different purposes. For example, a question and answer (Q&A) system may be used for automatically answering questions from customers on-the-fly in an online customer support setting; a troubleshooting system specialized in a particular field such as telecommunications may allow a technician to present observations and ask the system to provide an estimated diagnosis; or a robot may be deployed in a household to carry on conversations with residents of the household. FIG. 1 illustrates a typical LLM-based response generator 110 that, in response to a query, utilizes LLMs 120 previously trained to predict candidate responses in a response buffer 130 to be used by a response generator 140 to generate a response. To carry on a two-way communication, a response generated by an LLM needs to be relevant to what was previously said. When the topic of the communication changes, the responses need to be adapted to the changing topic. As a current LLM-based product such as what is shown in FIG. 1 generates a response based on continually cumulated predicted response buffered in 130, when the topic changes in the conversation, the response generated based on the content in the buffer will likely not be relevant to the new topic until the system gradually picks up the change.

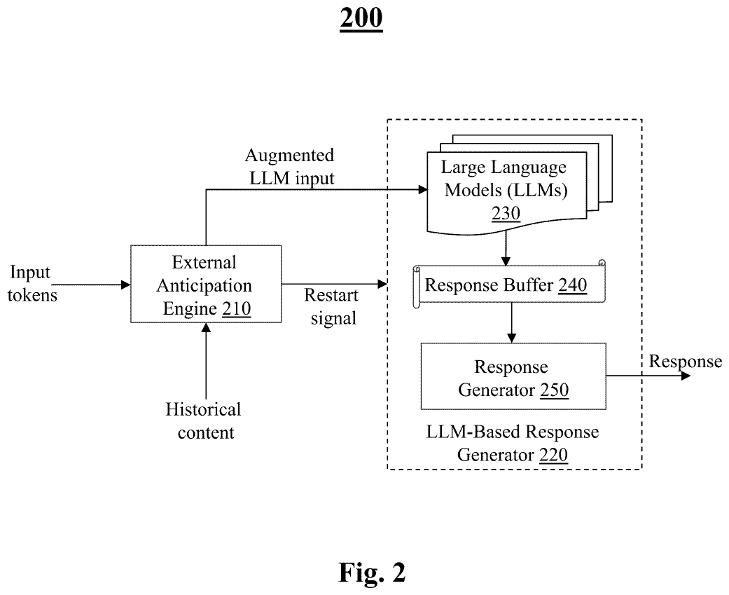

The present teaching discloses a scheme to address such issues in the traditional LLM based response generation schemes. An external anticipation engine is provided to predict, prior to the LLM-based response generation engine, look-ahead future tokens based on a partial input from an ongoing communication and its historical context related thereto and generates an augmented LLM input, incorporates both the actual input tokens in the partial input and its historical context as well as the predicted future tokens so that it provides enriched context to an LLM-based response generator to enable the generation of an improved response. FIG. 2 depicts an exemplary construct 200 of this scheme of generating responses in response to an input (e.g., a question, a query, or an ongoing conversation) using an external anticipation engine 210, in accordance with an embodiment of the present teaching. The external anticipation engine 210 takes a partial input having a sequence of actual input tokens from an ongoing communication and historical content for selecting a context relevant to the input tokens and generates an augmented LLM input for the LLM-based response generator 220. The external anticipation engine 210 is provided to predict the next n tokens based on the partial input (as it is received in real time such as a current block of input tokens) and relevant historical context. This phase of external anticipation helps to complete or extend the current block of input tokens, providing predicted future tokens as forward-looking context which makes the LLM-based response generator 220 in an attention phase more efficient and able to generate a more coherent response. The anticipation performed by the external anticipation engine 210 may be formalized as:

$$Anticipation ( Q , K , V ) = softmax ( \frac{{QK}^{T}}{\sqrt{{d}_{k}}} + {M}_{lookahead} ) V$$

where Q, K, and V represent the query, key, and value matrices, respectively, M_{lookahead} is a mask that limits the anticipation to the next n future positions, ensuring that the prediction is to produce only a short block of tokens, and dk is a dimension of key vectors used for scaling the softmax function of the attention mechanisms. According to the present teaching, the external anticipation engine 210 runs multiple anticipation time steps to generate several look-ahead predicted future tokens.

The LLM-based response generator 220 in FIG. 2 takes the augmented LLM input and generates a response. The LLMs 230 in the LLM-based response generator 220 may generate the current output tokens based on the augmented LLM input (extended sequence with both the current input tokens and the predicted look-ahead future tokens) so that the output tokens generated accordingly are contextually relevant and coherent with both the immediate and anticipated content. The operation of the LLMs 230 may be expressed as:

$$Attention ( Q , K , V ) = softmax ( \frac{{QK}^{T}}{\sqrt{{d}_{k}}} + {M}_{mask} ) V$$

where Mₘₐₛₖ corresponds to a padding mask that prevents the model from attending to padding tokens during this phase.

In addition, the external anticipation engine 210 according to the present teaching is also provided to detect a change in the ongoing communication in terms of content based on what the actual input tokens turn out to be, and what is predicted. When such a change is detected, the external anticipation engine 210 may signal, via a restart signal, the LLM-based response generator 220 so that appropriate actions, such as restarting content generation based on updated input, may be taken to adapt to the change.

In predicting future look-ahead tokens, the external anticipation engine 210 according to the present teaching may identify appropriate context relevant to the given input tokens from historical content input to the external anticipation engine 210. Such historical context may correspond to what has previously been said in the ongoing or previous communications that are relevant to the current input and can be identified from the historical content to provide an appropriate context for the external anticipation engine 210 to predict future tokens in a contextually sensitive manner. In some embodiments, the completed pairs of input tokens and the responses generated therefore may continually be added back to the historical content so that it is adapted to the ongoing situation.

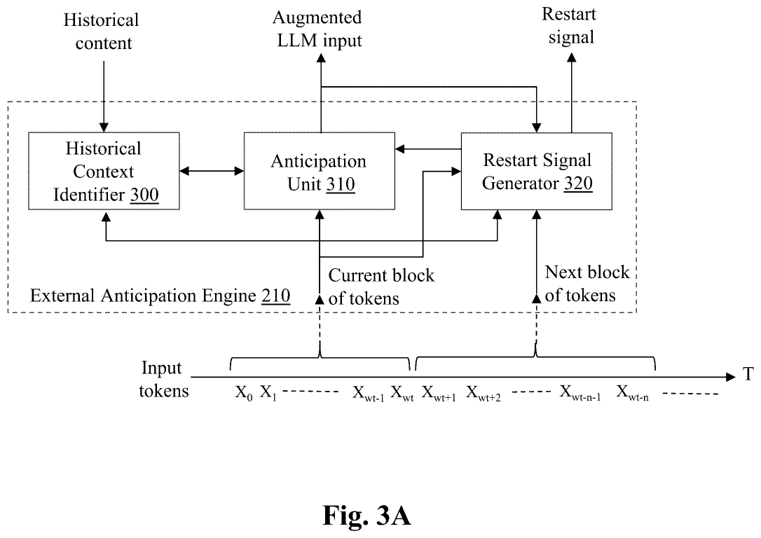

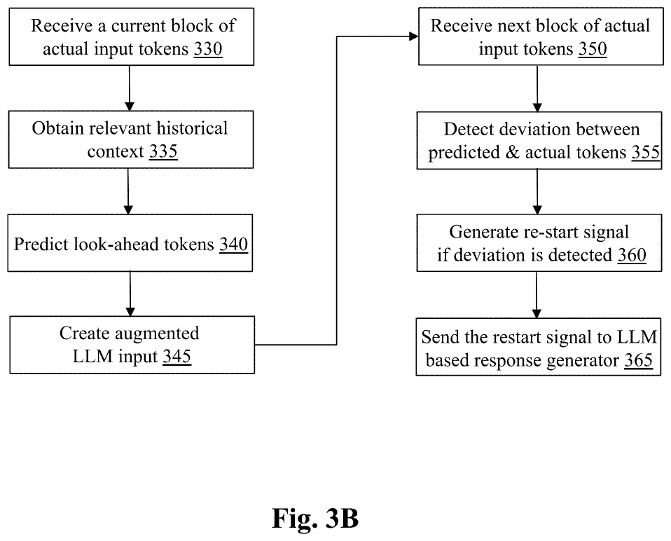

As discussed herein, the external anticipation engine 210 is provided to predict future tokens in a look-ahead manner (e.g., predicting three future tokens in the next three time steps). Such look-ahead future tokens predicted by the external anticipation engine 210 provide a forward-looking context for the current block of input tokens. As such, the external anticipation engine 210 generates the augmented LLM input to include the current block of input tokens, their historical context from previous communications, and the predicted look-ahead tokens, where the historical context represents the backward contextual information, the predicted future tokens provide forward contextual information. Thus, the augmented LLM input created by the external anticipation engine 210 according to the present teaching incorporates enriched contextual information relating to the current block of input tokens to allow the LLM-based response generator 220 enhanced ability to provide improved responses based on partial actual input. Details related to generation of the augmented LLM input are provided in reference to FIGS. 3A-5C.

As discussed herein, another function of the external anticipation engine 210 is related to detection of a change in an ongoing communication. As shown in FIG. 2, LLMs 230 in the LLM-based response generator 220 may generate predicted responses based on augmented LLM inputs and buffer the generated content in a response buffer 240. The content in the response buffer 240 may then be used by a response generator 250 to generate a final response, for example by transcribing digital text to audio format. When the LLM-based response generator 220 receives a restart signal from the external anticipation engine 210 as a change is detected in the communication, certain action may be adopted to, e.g., clear the content buffered in 240 and start new response generation based on the updated input, so that the generated text associated with previously predicted future tokens may not be used in generating a current session response moving forward.

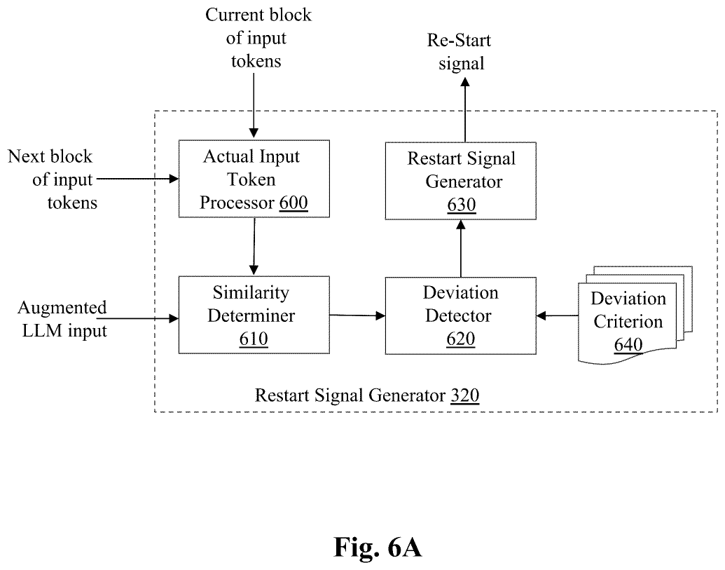

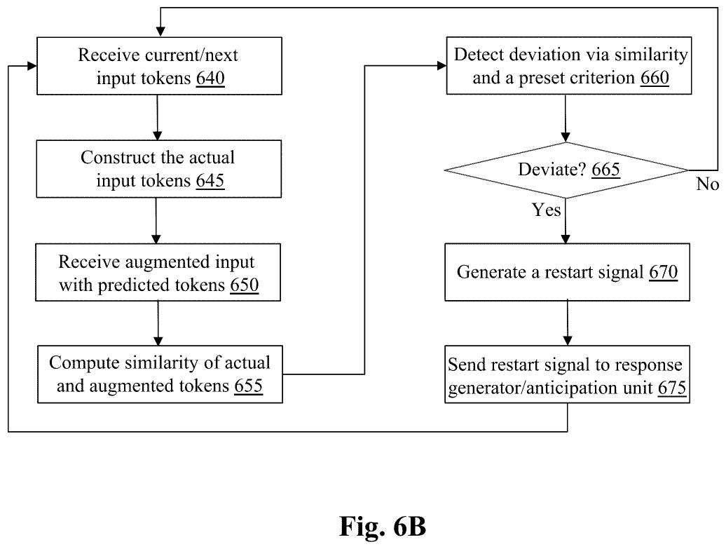

As the external anticipation engine 210 is positioned external to and prior to the LLM-based response generator 220 and provided to predict future tokens, it may be leveraged to determine whether there is a discrepancy between the received next block of actual input tokens and the predicted future tokens. If the discrepancy is significant, a deviation in subject of the communication may be detected. This detected change may be used to adjust the operation of both the external anticipation engine 210 and that of the LLM-based response generator. For example, when deviation between actual and predicted input is detected, the relevance of the historical context may also change. In addition, to react to the detected deviation, the LLM based response generator 220 may, e.g., flush the content of its response buffer and start a new content generation session from changed input. Details related to the function of the external anticipation engine 210 to detect a deviation in an ongoing communication are provided with reference to FIGS. 6A-6B.

FIG. 3A depicts an exemplary system diagram of the external anticipation engine 210, in accordance with an embodiment of the present teaching. In this illustrated embodiment, the external anticipation engine 120 comprises a historical context identifier 300, an anticipation engine 310, and a restart signal generator 320. The anticipation engine 310 is provided for predicting future tokens given a current block of input tokens prepended by relevant historical context identified by the historical context identifier 300 from historical content according to the current block of input tokens. As shown in FIG. 3A, input tokens correspond to a sequence of tokens obtained from an ongoing communication. Formally, a sequence x=(x₁, x₂, . . . , xₜ) represents an input sequence corresponding to a communication with tokens received in real time during the communication up to time step t in the first pair part (FPP) of the current adjacency pair. The input tokens may be arranged in a sequence in terms of time and a current block of the input sequence, denoted by x_{0:w}_{ₜ}, where wₜ is the block size, which can vary from block to block. The subscript 0:wₜ indicates the range of tokens being included in the block, starting from the first token in the FPP (index 0) up to the token at index wₜ. For example, assume a sequence of tokens arranged in terms of time t, i.e., X₀, X₁, . . . , X_{wt-1}, X_{wt}, X_{wt+1}, X_{wt+2}, . . . , X_{wt+n-1}, X_{wt+n}, as shown in FIG. 3A. These input tokens are continually made available during a communication. To provide augmented LLM input to the LLM-based response generator 220, they may be divided into different blocks of a certain size (e.g., wt) and each is provided to the anticipation engine 310 as a processing unit. In some embodiments, each block with input tokens X₀, X₁, X_{wt-1}, X_{wt} may be sent to the anticipation engine 310 for predicting a number of look-ahead future tokens.

As discussed herein, to predict look-ahead future tokens, historical context related to the input tokens in a current block may be identified from historical content. In some embodiments, historical content generated from previous communications may be represented as conversation pairs (e.g., question/answer pairs). The historical context identifier 300 may identify historical context related to the current block of input tokens by identifying pairs in historical content that are, e.g., semantically similar to the input tokens. With the historical context related to the current block of tokens, the anticipation engine 310 predicts look-ahead future tokens and generates the augmented LLM input based on the historical context, the current block of input tokens, and the predicted future tokens. The generated augmented LLM input is then sent to the LLM-based response generator 220 to predict a response. As the augmented input provided to the LLM-based response generator 220 is enriched with not only the current block of input tokens (as in the case of a traditional system as shown in FIG. 1) but also the past historical context as well as future predicted look-ahead tokens as forward-looking context, the augmented LLM input generated according to the present teaching enables the LLM-based response generator 220 to generate a more accurate response.

The restart signal generator 320 is provided for generating a restart signal if the predicted future tokens deviate from the actual future tokens from a next block of input tokens, e.g., X_{wt+1}, X_{wt+2}, . . . , X_{wt+n1-1}, X_{wt+n1} in the next block of actual input tokens, as illustrated in FIG. 3A. In some situations, the number of actual tokens and the number of predicted tokens may not be the same. If such a deviation is detected, a restart signal is generated and sent to the LLM-based response generator 220 to allow the LLM-based response generator 220 to act accordingly (e.g., reset or reinitiate the content generation in the response buffer 240).

FIG. 3B is a flowchart of an exemplary process of the external anticipation engine 210, in accordance with an embodiment of the present teaching. When the anticipation unit 310 receives, at 330, a current block of actual input tokens from an ongoing communication, it invokes the historical context identifier 300 to obtain, at 335, historical context from the historical content relevant to the received input tokens in the current block. When the historical context is received by the anticipation unit 310, it predicts, at 340, look-ahead future tokens and creates, at 345, an augmented LLM input based on the current block of input tokens, the relevant historical context, and the predicted look-ahead future tokens. The augmented LLM input is then sent to the LLM-based response generator 220 as shown in FIG. 2. To determine whether the predicted look-ahead future token deviates from the actual input tokens, the restart signal generator 320 receives, at 350, a next block of actual input tokens and forms an actual sequence of input tokens from the ongoing communication. Based on a predicted sequence of tokens in the augmented LLM input, including the current block of input tokens and the predicted look-ahead future tokens, the restart signal generator detects, at 355, content deviation between the actual sequence of tokens and the predicted sequence of tokens. If content deviation is detected between the actual sequence and the predicted sequence of tokens, the restart signal generator 320 generates, at 360, a restart signal and sends, at 365, the restart signal to the LLM-based response generator 220. As discussed herein, this restart mechanism according to the present teaching facilitates the rapid adaptation of the LLM-based response generation to produce responses with improved quality.

It is noted that the operation of the restart signal generator 320 is continuous. For example, a first block of actual input tokens may be provided to the anticipation unit 310 to predict a first set of look-ahead future tokens, and a second block of actual input tokens (adjacent to the first block as shown in FIG. 3A) is used by the restart signal generator 320 to detect deviation between the first set of look-ahead future tokens and the second block of actual input tokens. Then the second block of input tokens is provided to the anticipation unit 310 to predict a second set of look-ahead future tokens, and a third block of actual input tokens (adjacent to the second block) is used to compared with the second set of look-ahead future tokens to detect deviation, etc. In this manner, the detection of deviation is performed continuously.

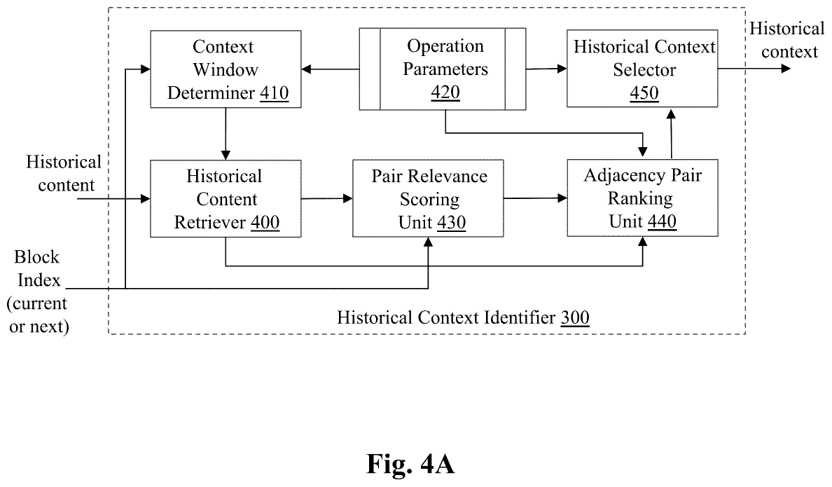

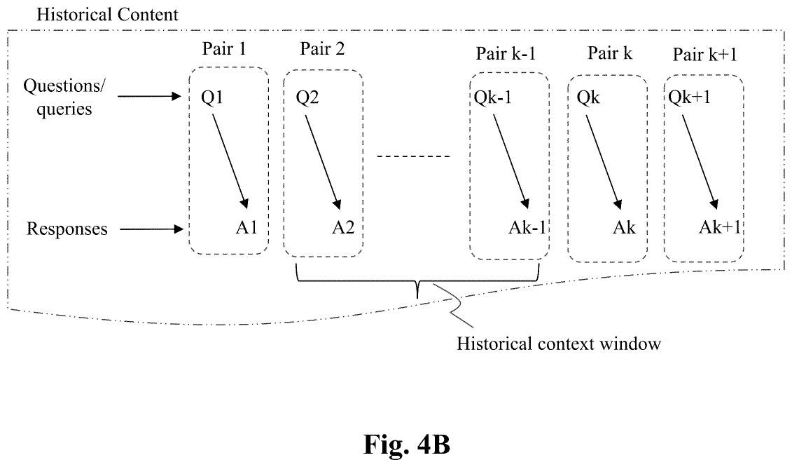

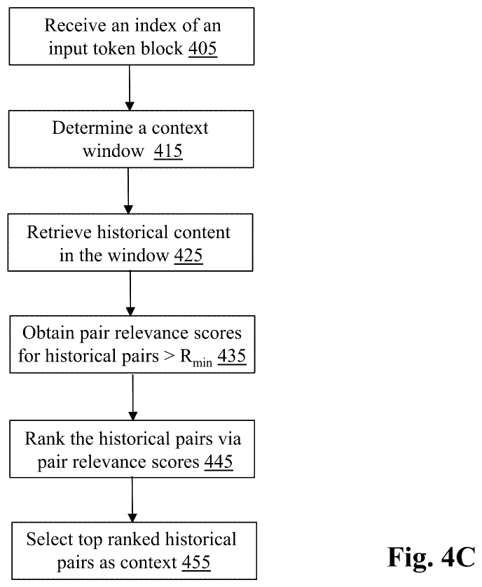

FIG. 4A depicts an exemplary system diagram of the historical context identifier 300, in accordance with an embodiment of the present teaching. In this illustrated embodiment, the historical context identifier 300 comprises a historical content retriever 400, a context window determiner 410, a pair relevance scoring unit 430, an adjacency pair ranking unit 440, and a historical context selector 450. The historical context identifier 300 takes a block (either current or next) of actual input tokens and historical content as input and outputs a historical context selected from the historical content for the block of input tokens based on relevance. In some embodiments, the historical content may be represented as adjacency pairs from communications, as illustrated in FIG. 4B. As shown, historical content includes adjacency pairs of questions/queries and responses extracted from communications, e.g., pair 1, pair 2, pair k−1, pair k, and pair k+1, and each pair includes a Q and an A. Each pair may be associated with a time stamp so that the pairs may be sequenced according to their time stamps. A current adjacency pair may sometimes also be referred to as a session. The adjacency pairs from the current dyadic conversation may be appended to the current historical content at the end of each session. To extract relevant historical context given a block of input tokens, a historical window may first be defined to limit the scope of pairs to be considered as the historical context. In some embodiments, the window size for the historical context may be determined based on, e.g., the maximum memory capacity of the model and/or the desired context length C. In some embodiments, the window is determined to always include the last session, denoted by T_{t′}. Denoting the historical window by

$${H}_{window}^{C}$$

for extracting relevant historical context, which is defined as:

$${H}_{window}^{C} = [ {T}_{max ( 0 , {t}^{′} - C )} , … , {T}_{t ′} ]$$

With the historical window as defined above, the pairs included therein are then used for relevance scoring to measure the relevance between each pair and the input tokens. The relevance scoring mechanism according to the present teaching may rank tokens included in the pairs in the window based on their importance and relevance to the current input tokens. For example, the importance of a term (token) in a pair may be determined based on its Term Frequency-Inverse Document Frequency (TF-IDF) score computed according to the term's frequency relative to the inverse frequency with respect to the communication. In addition, the relevance between the current input tokens (a block of text) and the historical adjacency pairs (also block of text) may be estimated via their semantic similarity between corresponding sentences or positional embedding vectors. In some embodiments, such semantic similarity may be determined using embeddings for the current block of text and historical adjacency pairs in the historical window. For example, a cosine similarity of the embeddings for the current block of text and that for the historical text may be computed to measure how contextually similar the two text blocks are.

Such metrics measuring both importance and relevance of each of the adjacency pairs Tᵢ in the historical window may then be combined to determine a relevant score as follows:

$$Relevance ( {T}_{i} ) = α \cdot TF - IDF ( {T}_{i} ) + ( 1 - α ) \cdot {S}_{C} ( E ( {T}_{i} ) , E ( {x}_{0 : {w}_{t}} ) )$$

where x_{0:w}_{ₜ} represents a block of actual input tokens, Tᵢ represents an adjacency pair or a segment of text, and E(Tᵢ) represents the embedding of that segment, S_{C} is the cosine similarity function, and a is a hyperparameter determined through cross-validation or similar methods and is used to balance components contributions. In some embodiments, the a value may be determined and tuned through cross-validation or grid search on a validation dataset to identify an optimal value that maximizes the performance in terms of relevance and coherence of the generated responses according to the specific need of each application.

With such obtained relevance scores for the adjacency pairs in the historical window, the adjacency pairs may be sorted based on their relevance scores while, e.g., preserving the temporal order in relevance groups. In some embodiments, a threshold Rₘᵢₙ may be set to indicate a minimum level of relevance so that any adjacency pair in the historical window that has a relevant score below the threshold may be discarded from current input. The historical context may then be determined from the remaining adjacency pairs. In some embodiments, an operational parameter K may be specified to represent the number of adjacency pairs to be selected to form the historical context. Given that, top adjacency pairs that have the top relevance scores may be selected, i.e.,

$${H}_{r} = Topk ( Relevance ( {H}_{window} ) > {R}_{min} )$$

which may then be used as the historical context for the given block of input tokens.

According to the present teaching, the historical window determiner 410 is provided for determining a context window based on parameters specified in 420. With the determined context window size, the historical content retriever 400 is provided to retrieve the historical content within the context window. Based on the historical content in the context window, the pair relevance scoring unit 430 is provided for determining the relevance score between each of the adjacency pairs in the retrieved historical content and the block of input token (text). Based on the relevance scores for the adjacency pairs in the historical window, the adjacency pair ranking unit 440 is provided to rank the adjacency pairs according to their relevance scores and remove those that have a relevance score below a preset threshold Rₘᵢₙ stored in 410 as an operational parameter. The historical context selector 450 then selects the top K (determined in 410 as an operational parameter) from the remaining ranked adjacency pairs as the historical context of the given block of input tokens.

FIG. 4C is a flowchart of an exemplary process of the historical context identifier, in accordance with an embodiment of the present teaching. When the index to a block of actual input tokens (either a current block or a next block) is received, at 405, the context window determiner 410 determines a context window at 415. To determine the historical context window for the block of input tokens, the historical content retriever 400 retrieves, at 425, historical content within the context window. As discussed herein, the retrieved historical content may include adjacency pairs in a sequence according to time stamps of the pairs. For each of such adjacency pairs, the pair relevance scoring unit 430 obtains, at 435, a relevant score as discussed herein and remove those adjacency pairs that have a relevant score lower than a set minimum threshold Rₘᵢₙ. For the remaining adjacency pairs with relevant scores higher than Rₘᵢₙ, the adjacency pair ranking unit 440 ranks, at 445, them to generate a ranked list of adjacency pairs. The historical context selector 450 then selects, at 455, top K adjacency pairs as the historical context of the given block of input tokens, while keeping the original temporal order of adjacency pairs within the historical content.

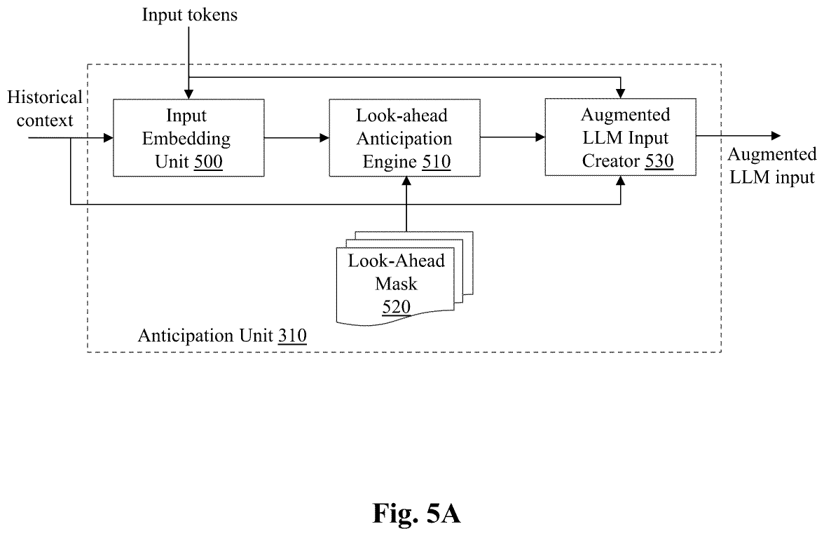

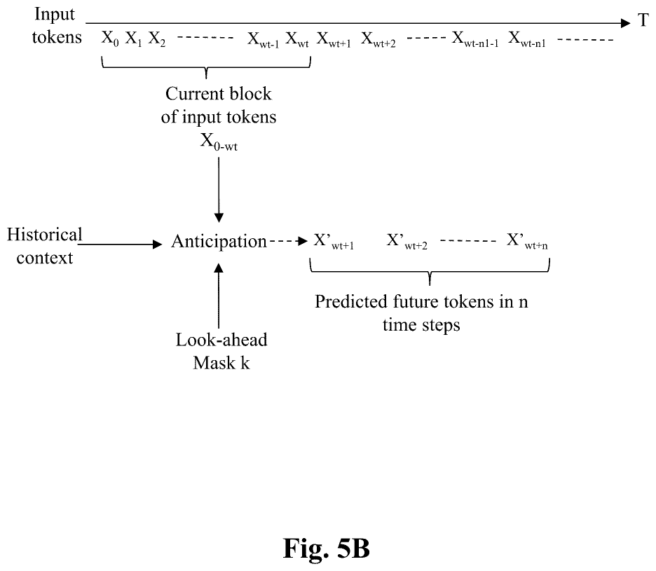

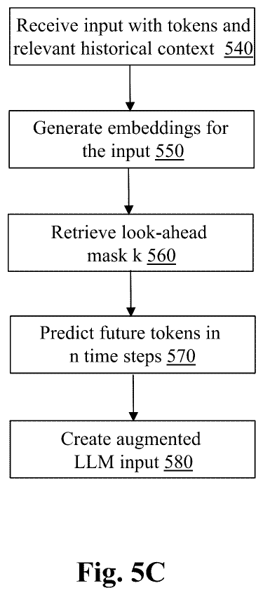

As discussed herein, such identified historical context for a block of input tokens (e.g., a current block) may be prepended to the input tokens for predicting more accurate look-ahead future tokens. As shown in FIG. 3A, the anticipation unit 310 takes a current block of input tokens and the historical context identified by the historical context identifier 300 as input, predicts n look-ahead future tokens, and generates an augmented LLM input. FIG. 5A depicts an exemplary system diagram of the anticipation unit 310, in accordance with an embodiment of the present teaching. In this illustrated embodiment, the anticipation unit 310 includes an input embedding unit 500, a look-ahead anticipation engine 510, and an augmented LLM input creator 530.

The input embedding unit 500 is provided for generating embedded input for prediction based on the current block of input tokens and its historical context. The look-ahead anticipation engine 510 is provided to conduct the iterative prediction process to iteratively predict n look-ahead future tokens. The look-ahead anticipation engine 510 may correspond to a trained model that may adopt a modified anticipation-self-attention transformers architecture, which may use any pre-trained LLM, such as large language model meta-AI (LLAMA), different versions of GPT, bidirectional encoder representations from transformers (BERT), etc. Based on the current block of input tokens, the historical context, and the predicted look-ahead future tokens, the augmented LLM input creator 530 is provided for generating the augmented LLM input to be output to the LLM-based response generator 220, as discussed herein.

FIG. 5B illustrates the scheme of look-ahead anticipation based on input tokens and related historical context, in accordance with an embodiment of the present teaching. As shown, when a current block of actual input tokens x_{0:w}_{ₜ} and its historical context are provided to the anticipation unit 310, the anticipation unit 310 operates based on a look-ahead mask that defines k as the maximum number of future tokens to be predicted and predicts n look-ahead future tokens. The number of predicted future tokens n may or may not equal to k. The n future tokens are predicted individually at each predictor time step in an iterative process as described below. During each iteration, the predicted future token is appended to the sequence of input tokens that will be used as input to the generative LLM in the current iteration. Details related to the operation of the anticipation unit 310 are described below.

The anticipation unit 310 is provided for predicting the next n tokens based on the current block of input token sequence x_{0:w}_{ₜ} and the relevant historical context. In some embodiments, the anticipation unit 310 performs this prediction by first embedding its input, including both the current input token sequence x_{0:w}_{ₜ} and its corresponding historical context Hᵣ, as follows:

$${H}_{input} = E ( [ {H}_{r} , {x}_{0 : {w}_{t}} ] )$$

The anticipation unit 310 then predicts the next n tokens by applying the anticipation function using the embedded input Hᵢₙₚᵤₜ to generate future tokens. The anticipation process may be iterated for several time steps to generate the desired number of look-ahead tokens, limited by the look-ahead mask mentioned above. After each iteration, the predicted future token(s) are appended to the input sequence to create an expanded input. This look-ahead approach allows the anticipation unit 310 to gradually build a more coherent and contextually relevant sequence by refining its predictions over multiple steps. Each new anticipation time step uses the expanded input, which includes the previously predicted token(s), to predict the next set of tokens. The iterative anticipation process at each time step i from time step/to n may be formalized as follows:

$${A}_{t + i} = Anticipation ( {Q}_{t + i - 1} , {K}_{t + i - 1} , {V}_{t + i - 1} )$$

where Qₜ₊ᵢ₋₁, Kₜ₊ᵢ₋₁, Vₜ₊ᵢ₋₁ are computed from the embedded input including the tokens up to Aₜ₊ᵢ₋₁ as in any anticipation mechanism and the anticipation unit 310 may process these matrices to predict the future tokens.

The input with predicted future tokens Aₜ₊ᵢ at an iteration may be appended to the actual input token sequence x_{0:w}_{ₜ} as follows, forming an expanded input sequence at each step i:

$${\hat{x}}_{0 : {w}_{t} + i} = ( {x}_{0 : {w}_{t} + i - 1} , {A}_{t + i} )$$

This expanded input sequence includes both the block of actual input tokens and the predicted future tokens. Such an anticipation process ensures that the input sequence is enriched with predicted future tokens at each time step in generating predicted look-ahead future tokens, providing a forward-looking context that enhances the coherence and relevance of the output generated by the attention mechanism.

The expanded input sequence, after all n look-ahead tokens are predicted, is \hat{x}_{0:w}_{ₜ}₊ₙ, which includes both actual and anticipated tokens, is embedded into a continuous representation H_{augmented}:

$${H}_{augmented} = E ( [ {H}_{r} , {\hat{x}}_{0 : {w}_{t} + n} ] )$$

where E corresponds to an embedding function compatible with generative LLM, and wₜ is the size of the current block of actual input tokens corresponding to the current session and n is the number of look-ahead predicted future tokens. This augmented input is then provided to the LLM-based response generator 220.

FIG. 5C is a flowchart of an exemplary process of the anticipation unit 310, in accordance with an embodiment of the present teaching. When the input embedding unit 500 receives, at 540, the current block of actual input tokens and the historical context, it generates, at 550, embedded input Hᵢₙₚᵤₜ. Upon receiving the embedded input, the anticipation engine 510 retrieves, at 560, a look-ahead mask 520 and operates to predict, at 570, future tokens in n time steps in an iterative process as discussed herein. The look-ahead mask 520 may define an upper limit k on the number of future tokens to predict (i.e., the maximum number of look-ahead time steps). In operation, the number of future tokens predicted by the anticipation engine 510 may be fewer, such as n<k. For example, in some situations, a question may have fewer tokens. Based on the input as well as the predicted future tokens, the augmented LLM input creator 530 creates, at 580, an augmented LLM input H_{augmented} and provides it to the LLM-based response generator 220.

With the augmented LLM input from the external anticipation engine 210, the LLM-based response generator 220 proceeds to rely on the attention mechanism in the LLMs 230 to produce output tokens based on the augmented LLM input. The LLMs 230 in the LLM-based response generator 220 may correspond to any available LLM models for the response based on received augmented LLM inputs from the external anticipation engine 210. The enriched context (both backward and forward) embedded in the augmented LLM input from the external anticipation engine 210 generated according to the present teaching enables the LLM-based response generator 220 to leverage both the actual input tokens, the historical context, and the look-ahead future tokens to produce a more coherent and contextually relevant response. The processing of the LLM-based response generator 220 may be expressed as follows:

$${H}_{t}^{l} = Attention ( {H}_{t}^{l - 1} , {H}_{augmented} , {H}_{augmented} , {M}_{mask} )$$

where

$${H}_{t}^{l}$$

represents the hidden state at time step t of layer l, which is computed for each time step at each layer of the LLMs 230, and Mₘₐₛₖ is a padding mask to be used to prevent the model from attending to padding tokens during this phase, allowing attention over all valid tokens, including the predicted look-ahead future tokens. That is, the LLMs 230 a provided for attending to all components in the input sequence H_{augmented}, ensuring that the generated output aligns with the enriched context in the augmented LLM input with the look-ahead future tokens predicted by the external anticipation engine 210.

In some embodiments, the external anticipation and attention mechanism of the LLM-based response generator 220 may be applied consecutively. To ensure stability and consistent activations, layered normalization and residual connections may be applied consistently across all sublayers, i.e., performing layer normalization before each sublayer (attention and feed-forward), and adding the residual connection after the sublayer computation.

As discussed herein, the external anticipation engine 210 is also provided for detecting a change in subject in an ongoing communication and if a deviation is detected, the processing as described herein may be adjusted to adapt to the changing situation. This is achieved by the restart signal generator 320 in the external anticipation engine 210. As new input tokens arrive (e.g., the next block of input tokens as shown in FIG. 3A), and if the input data x_{0:w}_{ₜ}₊ₙ deviates significantly from the last input vector \hat{x}_{0:w}_{ₜ}₊ₙ=(x_{0:w}_{ₜ}, A_{t+1:t+n}), a change may be detected so that a content generation restart mechanism may be activated to ensure that the generated responses remain relevant and coherent, even when the input changes unexpectedly.

To detect a deviation between the predicted tokens îₜ and the actual future input tokens xₜ, a similarity metric may be determined. In some embodiments, a cosine function may be used to compute the similarity and a deviation metric may be defined accordingly by the following:

$$Dev ( {x}_{0 : {w}_{t} + n} , {\hat{x}}_{0 : {w}_{t} + n} ) = 1 - {S}_{C} ( E ( {x}_{0 : {w}_{t} + n} ) , E ( {\hat{x}}_{0 : {w}_{t} + n} ) )$$

where E represents the embeddings function and S_{C} represents the similarity metric as a cosine between two embedding vectors. It is noted that the use of a cosine similarity is merely for illustration. Any other similarity measures may also be used to determine the similarity between two vectors.

A threshold 8 may be set for the deviation metric and may be determined through experimentation and cross-validation according to the needs of applications. If the deviation exceeds a preset threshold, a change is detected and, accordingly, a restart signal may be generated to inform the LLM-based response generator 220 so that the response generation process may be restarted by, e.g., resetting the hidden states to a stable state H_{stable}. In some embodiments, as the predicted look-ahead future tokens produced by the external anticipation engine 210 are not consistent with the actual input tokens, the process of identifying historical context via relevance scoring and predicting look-ahead future tokens may need to be repeated to generate a new augmented LLM input. This may ensure that the generated output/response remains aligned with the current input context.

FIG. 6A depicts an exemplary system diagram of the restart signal generator 320, in accordance with an embodiment of the present teaching. As discussed herein, the restart signal generator 320 is provided to detect a deviation of the augmented input with predicted look-ahead future tokens from the actual input tokens from the communication, limited only to the current session. In this illustrated embodiment, the restart signal generator 320 comprises an actual input token processor 600, a similarity determiner 610, a deviation detector 620, and a restart signal generator 630. The actual input token processor 600 takes both the current and next blocks of actual input tokens to form a sequence of actual input tokens. The similarity determiner 610 is provided for computing the similarity between the actual input tokens (the current and the next blocks combined) and the tokens in the augmented LLM input, which includes the current block of input tokens and the predicted look-ahead future tokens. As discussed herein, the similarity metric may be computed, e.g., using the formulation illustrated above based on embeddings for the actual input tokens and that for the tokens in the augmented LLM input. Based on the similarity metric, the deviation detector 620 detects the deviation according to the deviation criterion (e.g., a threshold 8 as discussed above). When the deviation is detected, the restart signal generator 630 is invoked to output a restart signal to the LLM-based response generator 220 so that the response generation process may be restarted by, e.g., resetting the hidden states to a stable state H_{stable} to allow the response generation process to adapt to the change.

In some embodiments, the restart signal may also be sent to the anticipation unit 510, as illustrated in FIG. 5A, because in this situation, the previously predicted look-ahead future tokens have been detected as inconsistent with the ongoing communication and should not be used as input to the LLM-based response generator 220 to generate a relevant response. In this case, the anticipation unit 510 may accordingly repeat the process of identifying appropriate historical context (via the historical context identifier 500) based on the new received block of input tokens and then predicting new look-ahead future tokens based on the current and next blocks of input token and the newly identified historical context.

FIG. 6B is a flowchart of an exemplary process of the restart signal generator 320, in accordance with an embodiment of the present teaching. The actual input token generator 600 receives, at 640, the current and next blocks of input tokens, it concatenates, at 645, the actual input token sequence x_{0:w}_{ₜ}₊ₙ. The similarity determiner 610 receives, at 650, the augmented LLM input, it may extract \hat{x}_{0:w}_{ₜ}₊ₙ=(x_{0:w}_{ₜ}, A_{t+1:t+n}) therefrom, and computes, at 655, the similarity between the actual input token sequence x_{0:w}_{ₜ}₊ₙ and \hat{x}_{0:w}_{ₜ}₊ₙ. Based on the computed similarity, the deviation detector 620 detects, at 660, whether a deviation exists based on the predetermined deviation criterion stored in 640. If a deviation is detected, determined at 665, the restart signal generator 630 generates, at 670, a restart signal and sends, at 675, to the LLM-based response generator 220 and the anticipation unit 510 for repeat the anticipation process. Then the process returns to 640 to continue to detect subsequent deviation. If no deviation is detected, determined at 665, the process also returns to 640 to continue to detect any subsequent deviations.

As disclosed herein, the process of response generation according to the present teaching incorporates the external anticipation engine 210 which provides a mechanism for predicting look-ahead tokens based on a block of input tokens as forward-looking context for the LLM-based response generator 220. In this manner, the augmented LLM input output by the external anticipation engine 210 with both backward (historical context) and forward (predicted look-ahead future tokens) context provide improved context for generating more relevant and accurate responses. The process is carried out using input tokens divided into multiple intervals and a restart mechanism is employed in the external anticipation engine 210 to detect, based on its predicted look-ahead tokens, deviation between different intervals based on the similarity between what is predicted and what is in the actual input token sequence. When a deviation is detected, the external anticipation engine 210 notifies the LLM-based response generator 220 to restart the response generation by, e.g., clear out the response previously buffered, so that the response generation process adapts more swiftly before the change occurs. In case of a restart, the anticipation unit 510 may also adapt by repeating the process of identifying newly relevant historical context and accordingly generating adapted future tokens.

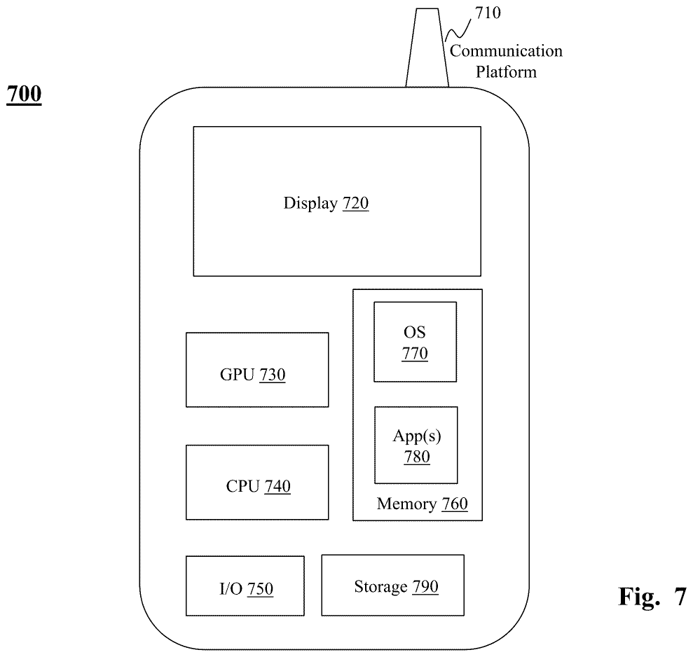

FIG. 7 is an illustrative diagram of an exemplary mobile device architecture that may be used to realize a specialized system implementing the present teaching in accordance with various embodiments. In this example, the user device on which the present teaching may be implemented corresponds to a mobile device 700, including, but not limited to, a smart phone, a tablet, a music player, a handled gaming console, a global positioning system (GPS) receiver, and a wearable computing device, or a mobile computational unit in any other form factor. Mobile device 700 may include one or more central processing units (“CPUs”) 740, one or more graphic processing units (“GPUs”) 730, a display 720, a memory 760, a communication platform 710, such as a wireless communication module, storage 790, and one or more input/output (I/O) devices 750. Any other suitable component, including but not limited to a system bus or a controller (not shown), may also be included in the mobile device 700. As shown in FIG. 7, a mobile operating system 770 (e.g., iOS, Android, Windows Phone, etc.) and one or more applications 780 may be loaded into memory 760 from storage 790 to be executed by the CPU 740 or GPUs 730. The applications 780 may include a user interface or any other suitable mobile apps for information exchange, analytics, and management according to the present teaching on, at least partially, the mobile device 700. User interactions, if any, may be achieved via the I/O devices 750 and provided to the various components thereto.

To implement various modules, units, and their functionalities as described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

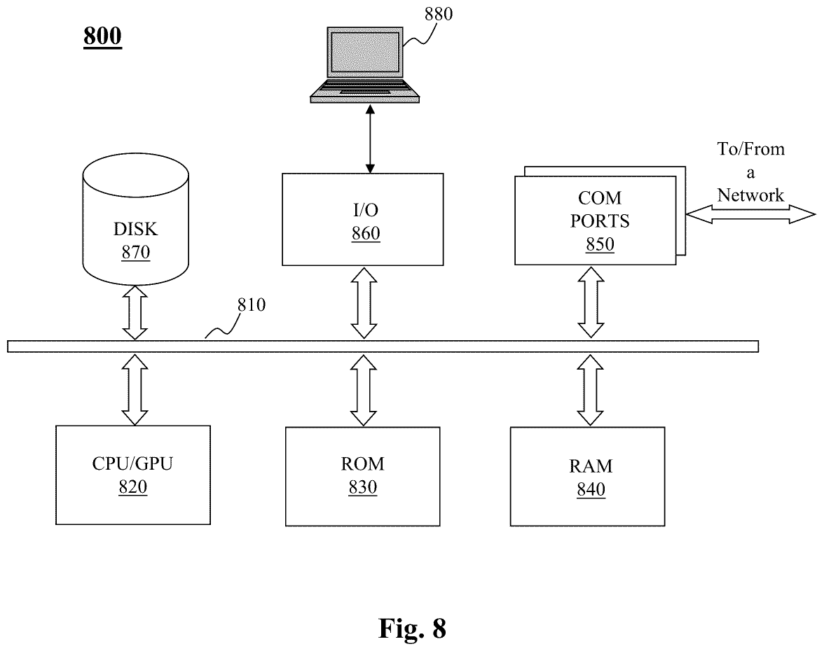

FIG. 8 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 800 may be used to implement any component or aspect of the framework as disclosed herein. For example, the information processing and analytical method and system as disclosed herein may be implemented on a computer such as computer 800, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 800, for example, includes COM ports 850 connected to and from a network connected thereto to facilitate data communications. Computer 800 also includes one or more central processing unit (CPU) and/or one or more graphic processing units (“GPUs”) 820, in the form of one or more processors, for executing program instructions. The exemplary computer platform includes an internal communication bus 810, program storage and data storage of different forms (e.g., disk 870, read only memory (ROM) 830, or random-access memory (RAM) 840), for various data files to be processed and/or communicated by computer 800, as well as possibly program instructions to be executed by the one or more CPU/GPUs 820. Computer 800 also includes an I/O component 860, supporting input/output flows between the computer and other components therein such as user interface elements 880. Computer 800 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

It is noted that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

In the preceding specification, various example embodiments have been described with reference to the accompanying drawings. It will, however, be evident that various modifications and changes may be made thereto, and additional embodiments may be implemented, without departing from the broader scope of the present teaching as set forth in the claims that follow. The specification and drawings are accordingly to be regarded in an illustrative rather than restrictive sense.

We claim:

1. A method, comprising:
receiving a current block of input tokens from an ongoing communication;
identifying, from historical content, historical context relevant to the current block of input tokens;
predicting a plurality of future tokens based on the current block of input tokens and the historical context;
generating an augmented input based on the historical context and a predicted sequence of tokens which includes the current block of input tokens and the predicted plurality of future tokens;
sending the augmented input to a Large Language Model (LLM)-based response generator for generating a response;
receiving a next block of input tokens from the ongoing communication, wherein the current and the next blocks of input tokens are consecutive and form an actual sequence of tokens;
detecting content deviation between the actual and the predicted sequences of tokens;
generating, if the content deviation is detected, a restart signal; and
sending the restart signal to the LLM-based response generator to initiate a restart process in generating a response.

2. The method of claim 1, wherein the identifying historical context comprises:
determining a context window associated with the historical context based on the current block;
retrieving the historical content within the context window, wherein the retrieved historical content corresponds to previous communications represented by a plurality of query/answer (Q&A) pairs;
obtaining a relevance score between each of the plurality of Q&A pairs and the current block of input tokens;
ranking the plurality of Q&A pairs based on their respective relevance scores;
selecting a predetermined number of top ranked Q&A pairs; and
creating the historical context for the current block of input tokens based on the selected top ranked Q&A pairs.

3. The method of claim 2, wherein the obtaining a relevance score comprises:
determining a first metric representing importance of terms in the Q&A pair;
determining a second metric representing semantic similarity between the Q&A pair and the current block of input tokens;
retrieving an operational parameter for combining the first and the second metric; and
determining the relevance score for the Q&A pair based on the first metric and the second metric in accordance with the operational parameter.

4. The method of claim 3, wherein
the first metric is a term frequency-inverse document frequency (TF-IDF) score; and
the second metric is a score measuring similarity between first embeddings of the Q&A pair and second embeddings of the current block of input tokens.

5. The method of claim 1, wherein the predicting the plurality of future tokens comprises:
receiving an input including the historical context and the currently block of input tokens;
obtaining embeddings for the input;
retrieving a look-ahead mask that defines a number of look-ahead future tokens to be predicted in the number of iterative time steps;
in each of the number of time steps,
predicting a look-ahead future token based on the embeddings of the input,
expanding the input by adding the predicted look-ahead future token to the input, and
updating the embeddings for the input based on the expanded input.

6. The method of claim 1, wherein the detecting content deviation comprises:
obtaining
a first measure indicative of similarity between the actual sequence of tokens and the predicted sequence of tokens, and
a second measure based on the first measure representing a discrepancy between the actual and predicted sequences of tokens; and
determining whether the predicted sequence of tokens deviates from the actual sequence of tokens based on the discrepancy in accordance with a predetermined criterion.

7. The method of claim 1, further comprising:
identifying, from historical content, updated historical context relevant to the next block of input tokens;
predicting a new set of future tokens based on the next block of input tokens and the updated historical context;
generating an updated augmented input based on the updated historical context and an updated predicted sequence of tokens which includes the next block of input tokens and the new set of future tokens; and
sending the updated augmented input to the LLM-based response generator for generating a response.

8. A machine-readable and non-transitory medium having information recorded thereon, wherein the information, when read by the machine, causes the machine to perform the following steps:
receiving a current block of input tokens from an ongoing communication;
identifying, from historical content, historical context relevant to the current block of input tokens;
predicting a plurality of future tokens based on the current block of input tokens and the historical context;
generating an augmented input based on the historical context and a predicted sequence of tokens which includes the current block of input tokens and the predicted plurality of future tokens;
sending the augmented input to a Large Language Model (LLM)-based response generator for generating a response;
receiving a next block of input tokens from the ongoing communication, wherein the current and the next blocks of input tokens are consecutive and form an actual sequence of tokens;
detecting content deviation between the actual and the predicted sequences of tokens;
generating, if the content deviation is detected, a restart signal; and
sending the restart signal to the LLM-based response generator to initiate a restart process in generating a response.

9. The medium of claim 8, wherein the identifying historical context comprises:
determining a context window associated with the historical context based on the current block;
retrieving the historical content within the context window, wherein the retrieved historical content corresponds to previous communications represented by a plurality of query/answer (Q&A) pairs;
obtaining a relevance score between each of the plurality of Q&A pairs and the current block of input tokens;
ranking the plurality of Q&A pairs based on their respective relevance scores;
selecting a predetermined number of top ranked Q&A pairs; and
creating the historical context for the current block of input tokens based on the selected top ranked Q&A pairs.

10. The medium of claim 9, wherein the obtaining a relevance score comprises:
determining a first metric representing importance of terms in the Q&A pair;
determining a second metric representing semantic similarity between the Q&A pair and the current block of input tokens;
retrieving an operational parameter for combining the first and the second metric; and
determining the relevance score for the Q&A pair based on the first metric and the second metric in accordance with the operational parameter.

11. The medium of claim 10, wherein
the first metric is a term frequency-inverse document frequency (TF-IDF) score; and
the second metric is a score measuring similarity between first embeddings of the Q&A pair and second embeddings of the current block of input tokens.

12. The medium of claim 8, wherein the predicting the plurality of future tokens comprises:
receiving an input including the historical context and the currently block of input tokens;
obtaining embeddings for the input;
retrieving a look-ahead mask that defines a number of look-ahead future tokens to be predicted in the number of iterative time steps;
in each of the number of time steps,
predicting a look-ahead future token based on the embeddings of the input,
expanding the input by adding the predicted look-ahead future token to the input, and
updating the embeddings for the input based on the expanded input.

13. The medium of claim 8, wherein the detecting content deviation comprises:
obtaining
a first measure indicative of similarity between the actual sequence of tokens and the predicted sequence of tokens, and
a second measure based on the first measure representing a discrepancy between the actual and predicted sequences of tokens; and
determining whether the predicted sequence of tokens deviates from the actual sequence of tokens based on the discrepancy in accordance with a predetermined criterion.

14. The medium of claim 8, wherein the information, when read by the machine, further causes the machine to perform the following steps:
identifying, from historical content, updated historical context relevant to the next block of input tokens;
predicting a new set of future tokens based on the next block of input tokens and the updated historical context;
generating an updated augmented input based on the updated historical context and an updated predicted sequence of tokens which includes the next block of input tokens and the new set of future tokens; and
sending the updated augmented input to the LLM-based response generator for generating a response.

15. A system, comprising:
a historical context identifier implemented by a processor and configured for identifying, from historical content, historical context relevant to a current block of input tokens from an ongoing communication;
an anticipation unit implemented by a processor and configured for:
predicting a plurality of future tokens based on the current block of input tokens and the historical context,
generating an augmented input based on the historical context and a predicted sequence of tokens which includes the current block of input tokens and the predicted plurality of future tokens, and
sending the augmented input to a Large Language Model (LLM)-based response generator for generating a response; and
a restart signal generator implemented by a processor and configured for:
receiving a next block of input tokens from the ongoing communication, wherein the current and the next blocks of input tokens are consecutive and form an actual sequence of tokens,
detecting content deviation between the actual and the predicted sequences of tokens,
generating, if the content deviation is detected, a restart signal, and
sending the restart signal to the LLM-based response generator to initiate a restart process in generating a response.

16. The system of claim 15, wherein the identifying historical context comprises:
determining a context window associated with the historical context based on the current block;
retrieving the historical content within the context window, wherein the retrieved historical content corresponds to previous communications represented by a plurality of query/answer (Q&A) pairs;
obtaining a relevance score between each of the plurality of Q&A pairs and the current block of input tokens;
ranking the plurality of Q&A pairs based on their respective relevance scores;
selecting a predetermined number of top ranked Q&A pairs; and
creating the historical context for the current block of input tokens based on the selected top ranked Q&A pairs.

17. The system of claim 16, wherein the obtaining a relevance score comprises:
determining a first metric representing importance of terms in the Q&A pair;
determining a second metric representing semantic similarity between the Q&A pair and the current block of input tokens;
retrieving an operational parameter for combining the first and the second metric; and
determining the relevance score for the Q&A pair based on the first metric and the second metric in accordance with the operational parameter.

18. The system of claim 17, wherein
the first metric is a term frequency-inverse document frequency (TF-IDF) score; and
the second metric is a score measuring similarity between first embeddings of the Q&A pair and second embeddings of the current block of input tokens.

19. The system of claim 15, wherein the predicting the plurality of future tokens comprises:
receiving an input including the historical context and the current block of input tokens;
obtaining embeddings for the input;
retrieving a look-ahead mask that defines a number of look-ahead future tokens to be predicted in the number of iterative time steps;
in each of the number of time steps,
predicting a look-ahead future token based on the embeddings of the input,
expanding the input by adding the predicted look-ahead future token to the input, and
updating the embeddings for the input based on the expanded input.

20. The system of claim 15, wherein the detecting content deviation comprises:
obtaining
a first measure indicative of similarity between the actual sequence of tokens and the predicted sequence of tokens, and
a second measure based on the first measure representing a discrepancy between the actual and predicted sequences of tokens; and
determining whether the predicted sequence of tokens deviates from the actual sequence of tokens based on the discrepancy in accordance with a predetermined criterion.
